(19) United States
(12) Patent Application Publication
(10) Pub. No.: US 2020/0317094 A1
(43) Pub. Date: Oct. 8, 2020

(54) CAR SEAT AND CONNECTION SYSTEM

(71) Applicant: Pidyon Controls Inc., New York, NY (US)

(72) Inventors: Yochanan Cohen, New York, NY (US); Ekaterina Kravchenko, Philadephia, PA (US); Ahmet T. Becene, West Simsbury, CT (US); Peter Byar, Willingboro, NJ (US); Yaacov Goland, Pacific Palisades, CA (US); Velissa Van Scoyoc, Philadelphia, PA (US); Jonathan I. Gordon, New Haven, CT (US); Christian Mannino, Westport, CT (US)

(73) Assignee: Pidyon Controls Inc., New York, NY (US)

(21) Appl. No.: 16/841,666

(22) Filed: Apr. 6, 2020

Related U.S. Application Data
(63) Continuation of application No. 16/754,115, filed on Apr. 6, 2020.
(60) Provisional application No. 62/569,090, filed on Oct. 6, 2017.

(51) Int. Cl. B60N 2/28; B60N 2/54; B60N 2/50

(52) U.S. Cl. CPC B60N 2/2812; B60N 2/2821; B60N 2/2806; B60N 2/2884; B60N 2/54; B60N 2/504; B60N 2/286; B60N 2/2881

(57) ABSTRACT

Embodiments of a car seat include an outer protective shell, an inner seat, a suspension system connecting and permitting relative movement between the inner seat and the outer protective shell. The suspension system may include a plurality of plastically deformable suspension elements. Also, embodiments of a car seat system include a frame constructed to couple to a vehicle seat. The frame and/or the car seat may have a plastically deformable energy absorbing element extending outwardly to absorb energy, such as from a side impact. The frame may include tubular members filled with reinforcing material. The frame may have a connection arrangement with the car seat to restrict connection of the car seat so that it can only be installed in predefined orientations relative to the frame. The car seat may have a harness that includes a bolster panel or straps to limit movement of an occupant in the car seat.

### BACKGROUND

### 1. Field

The present disclosure relates to car seats. More particularly, the present disclosure relates to safety car seats. The safety car seats may be for infants or children, although this application is not limited thereto.

### 2. State of the Art

The most common cause of death for children aged 1-5 in developed countries is by accident, and the leading cause of death by accident is car accidents. When properly installed in passenger cars, child safety seats have been reported to reduce fatal injury by about 71% for children under age one and by about 54% for toddlers aged 1-4. Nonetheless, in the U.S. alone, over 250 children aged 0-4 are fatally injured every year while properly restrained in their car seats.

In addition, to the fatalities, every year, thousands of children who are properly restrained in car seats still sustain incapacitating injuries resulting from car accidents. By far the most common severe injuries are head injuries, including cerebrum injuries (contusions or lacerations), concussions, skull vault and skull base fractures, subarachnoid hemorrhages, and subdural hematomas. Other common severe injuries are thoracic (lung and rib), abdominal (bowel, liver, spleen, kidney), spine, and upper extremity (clavicle, humerus, radius/ulna) and lower extremity (pelvis, femur, tibia/fibula) injuries. The injury outcome in children can be worse than similar injuries sustained by adults, and children who suffer traumatic brain injuries can experience lasting or late-appearing neuropsychological problems. For example, frontal lobe functions develop relatively late in a child's growth, so that injury to the frontal lobes may not become apparent until the child reaches adolescence.

According to the U.S. National Highway Traffic and Safety Administration (NHTSA), children under the age of one should always ride in a rear-facing car seat that has a harness. While it is recommended that rear-facing seats be used as long as possible, it is recognized that children aged 1 and over will wish to face forward. NHTSA recommends that children aged 1-3 (and older if they have not reached a certain height and weight) use a forward-facing car seat with a harness and tether that limits the child's forward movement during a crash.

There are many types of car seats available for purchase Infant seats recommended for children under age 1 are typically rear-facing. Many include a base that is belted or tethered into the car and a seat that can latch into the base. The seat often includes a handle so that the seat may be carried when it is unlatched from the base (i.e., from the car). A popular car seat option for infants as well as children is a “convertible” car seat that may be oriented in a rear-facing position and then “converted” to a front-facing position. Some convertible car seats may even convert into a booster seat for children weighing up to 100 pounds. Typically the convertible car seats are strapped into the car using the car seat-belt, or are anchored to the car frame directly using a LATCH (Lower anchors and Tethers for children) system. All car seats offer a harness for strapping the child into the seat. The usual harness is a five-point safety harness. The car seats tend to be formed from injection molded plastic, typically at least 5 mm (0.2 in) thick, and the seats (with base in the case of the infant seats) typically weigh 7 kgs (15.4 lbs) or more.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

According to one aspect of the disclosure, a car seat system includes a frame constructed to couple to a vehicle seat and to a car seat. The frame includes a vertical portion that extends vertically upward substantially along a vehicle seatback. The vertical portion may extend at least half of the height of vehicle seatback. The frame also includes a horizontal portion extending from a lower end of the vertical portion at an angle with respect to the vertical portion. The horizontal portion is constructed to extend along a vehicle seat when the frame is coupled to the vehicle, and the horizontal portion is configured to couple to the car seat. In one embodiment, the car seat system also includes a first plastically deformable energy absorber coupled to at least one of the vertical and horizontal portion of the frame which extends outwardly in a direction away from a center of the frame. The first plastically deformable energy absorber may be extendable and retractable relative to the frame. Also, the first plastically deformable energy absorber may be structured as honeycomb, lattice, or mesh, and may be formed of metals or plastics.

In one embodiment, a car seat system includes a car seat having a front, back, and sides, and a frame with the car seat configured to couple to a horizontal portion of the frame. A first plastically deformable energy absorber extends beyond at least one of the sides of the car seat when the car seat is coupled to the horizontal portion of the frame. In one embodiment, the system includes a second plastically deformable energy absorber coupled to at least one side of the car seat and extends outwardly in a direction away from a center of the car seat. In one embodiment, the car seat includes a carrying handle extending across the car seat to its sides, and the second plastically deformable energy absorber may be coupled to the carrying handle. The second plastically deformable energy absorber may be extendable and retractable relative to the car seat. Also, the second plastically deformable energy absorber may be structured as honeycomb, lattice, or mesh, and may be formed of metals or plastics.

According to another aspect, a car seat system includes a frame constructed to couple to a vehicle seat and to a car seat. The frame includes a vertical portion that extends vertically upward substantially along a vehicle seatback. The vertical portion may extend at least half of the height of vehicle seatback. Also, the frame includes a horizontal portion extending from a lower end of the vertical portion at an angle with respect to the vertical portion. The horizontal portion is constructed to extend along a vehicle seat when the frame is coupled to the vehicle and the horizontal portion is configured to couple to the car seat. At least one of the vertical portion and the horizontal portion include a tubular portion having a wall of a first material surrounding a space that is filled at least partially with second, solid material that is different from the first material. In one embodiment, the first material is metal and the second material is a foam including expanded polystyrene foam.

According to another aspect, a six-point car seat harness system includes a five point harness configured for coupling to a car seat, the five point harness including two shoulder straps, a chest buckle for connecting the shoulder straps together, two thigh straps, a crotch strap, and a crotch buckle for connecting the shoulder straps, the crotch strap, and the thigh straps together. The harness system also includes a bolster panel configured to extend over and across a seatback of the car seat and be coupled to the car seat and cover over at least the shoulder straps and the chest buckle of the five point harness. The bolster panel may be configured to be vertically adjustable with respect to the shoulder straps.

According to another aspect, a nine-point car seat harness system includes a five point harness configured for coupling to a car seat, the five point harness including two shoulder straps, a chest buckle for connecting the shoulder straps together, two thigh straps, a crotch strap, and a crotch buckle for connecting the shoulder straps, the crotch strap, and the thigh straps together. Also, the harness system includes a first pair of straps configured to extend between the chest buckle and respective connection locations on opposite lateral sides of the five point harness; and a second pair of straps configured to extend between the crotch buckle and the respective connection locations.

According to another aspect, a car seat system includes a frame constructed to couple to a vehicle seat and to a car seat. The frame includes a vertical portion that extends vertically upward substantially along a vehicle seatback. The vertical portion may extend at least half of the height of vehicle seatback. Also, the frame includes a horizontal portion extending from a lower end of the vertical portion at an angle with respect to the vertical portion. The horizontal portion is constructed to extend along a vehicle seat when the frame is coupled to the vehicle. The horizontal portion is configured to couple to the car seat in only a forward or rear facing orientation of the car seat. In one embodiment, the horizontal portion of the frame includes a plurality of female connection sockets that are configured to mate with a plurality of corresponding male projections extending from the car seat. In one embodiment, at least one of the connection sockets is configured to lock with a corresponding projection. In one embodiment, the system further includes a car seat having a bottom side from which the plurality of projections extend. In one embodiment, the sockets have an inner tapered surface and the projections have an outer tapered surface that mates with the inner tapered surface of the sockets.

According to another aspect, a car seat for an occupant includes an outer protective shell, an inner seat, and a suspension system comprised of suspension elements that couple and permit relative movement between the inner seat and the outer protective shell. The suspension system suspends the inner seat substantially within the outer protective shell. The suspension elements include an outer plastically deformable band surrounding a plastically deformable insert. In one embodiment, a first length of each band is connected to an outer surface of the inner seat and a second length of each band is connected to an inner surface of the outer protective shell. The straps may be formed of at least one of metals and plastics. In one embodiment, the insert includes an outer filler material that surrounds an inner filler material. The inner filler material is more compressible than the outer filler material. In one embodiment, the outer filler material has an inner surface configured to limit the amount of deformation of the suspension element.

According to yet another aspect, a car seat for an occupant includes an outer protective shell, and an inner seat suspended from the outer protective shell and suspended within the outer protective shell. The inner seat defines at least one vertical slot through a seatback portion of the inner seat. Also, the car seat includes a harness system for securing the occupant to the inner seat. The harness system is coupled to the inner seat. The harness system includes a shoulder pad height adjuster configured to slide vertically within the at least one vertical slot in the inner seat. Also, the harness system includes a pair of shoulder pads extending horizontally from the shoulder pad height adjuster. Further, the harness system includes a pair of shoulder straps connected to respective shoulder pads and extending to a connector. In addition, the harness system includes a crotch strap and crotch buckle coupled to a seat base of the inner seat. The crotch buckle is configured to connect to the connectors of the shoulder straps. The shoulder pad height adjuster is configured to be selectively positioned at a user-selected height to adjust the height of the shoulder pads. In one embodiment, the car seat includes a bolster panel configured to be coupled to the car seat across a seatback area of the inner seat and cover over at least the shoulder straps and extend between the shoulder straps.

Also, in one embodiment, the car seat also includes a chest buckle connecting the shoulder straps together at a location vertically spaced above the crotch buckle, a first pair of straps configured to extend between the chest buckle and respective connection locations on opposite lateral sides of the shoulder straps, and a second pair of straps configured to extend between the crotch buckle and the respective connection locations.

### BRIEF DESCRIPTION OF THE DRAWINGS

FIG. 1 is a transparent perspective illustration of a car seat described in co-owned U.S. Patent Application Publication No. 2016/03322542 (Cohen et al.).

FIG. 2 is an assembly view of a suspension element in accordance with an aspect of the disclosure which can substitute for a respective one of the straps of the suspension system 40 shown in FIG. 1.

FIGS. 3A to 3C show the parts of the suspension element of FIG. 2 as they progressively deform as a result of a modeled energy input to the suspension element.

FIG. 4 shows a load level map of the parts of the suspension element at the deformation state of FIG. 3C.

FIG. 5 is a view of a car seat mounting frame described in co-owned U.S. Patent Application Publication No. 2016/03322542 (Cohen et al.).

FIGS. 6a to 6g show embodiments of a car seat mounting frame in accordance with aspects of the disclosure.

FIG. 7 shows a view of the car seat mounting frame along section FIG. 7-FIG. 7 in FIG. 6a.

FIG. 8a shows the car seat of FIG. 1 with a handle and side impact energy absorbing elements in accordance with another aspect of the disclosure.

FIG. 8b shows the car seat of FIG. 1 with seatbelt clamps in accordance with another aspect of the disclosure.

FIG. 9 shows a view of the car seat mounting frame along section FIG. 9-FIG. 9 in FIG. 6a.

FIG. 10 is a front view of an embodiment of an inner seat that can be used with the car seat of FIG. 1 and has a harness system in accordance with an aspect of the disclosure.

FIG. 11 is a front view of an embodiment of an inner seat that can be used with the car seat of FIG. 1 and has a harness system in accordance with an aspect of the disclosure.

FIG. 12 shows a car seat mounting frame in accordance with an aspect of the disclosure.

FIG. 13 shows a top plan view of the car seat mounting frame of FIG. 12, with only the female sockets of the frame shown for clarify of illustration.

FIG. 14 shows a schematic side section view of a latching female socket of the frame shown in FIG. 12 along with a corresponding male projection.

FIG. 15 is a front view of an embodiment of an inner seat that can be used with the car seat of FIG. 1 and has a harness system in accordance with an aspect of the disclosure.

FIG. 16 is a front view of an embodiment of an inner seat that can be used with the car seat of FIG. 1 and has a harness system in accordance with an aspect of the disclosure.

FIG. 17 is a front view of an embodiment of an inner seat that can be used with the car seat of FIG. 1 and has a harness system in accordance with an aspect of the disclosure.

FIG. 18 is an elevation view of the left side of the inner seat shown in FIG. 17.

FIG. 18a is a detailed view of a cylinder shown in FIG. 18.

FIG. 19 is an elevation view of the rear side of the inner seat shown in FIG. 17.

FIG. 19a is an exploded section view of an engagement and release mechanism of the seat shown in FIG. 19.

### DETAILED DESCRIPTION

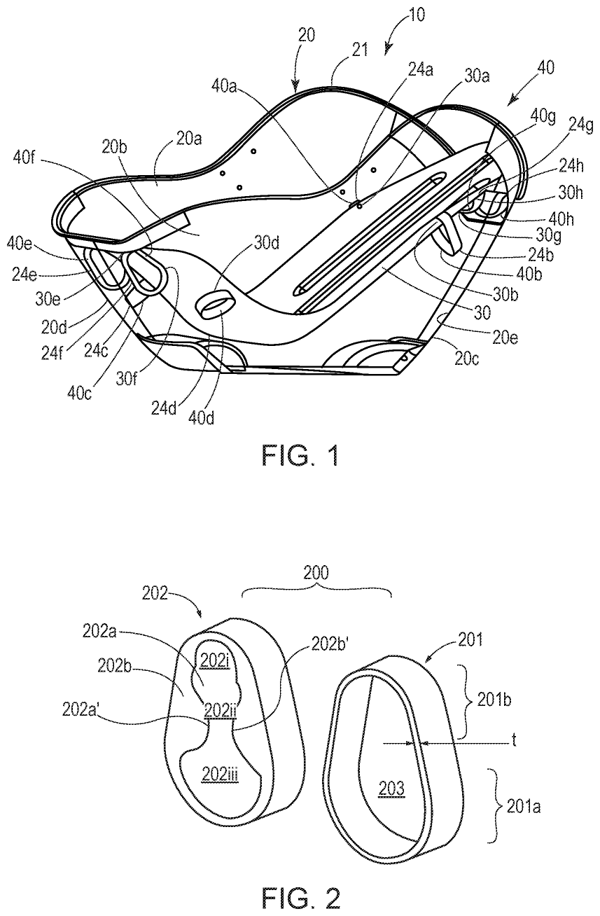

FIG. 1 shows a car seat 10, which is also presented as FIG. 1 in co-owned U.S. Patent Application Publication No. 2016/0332542 (Cohen et al.). The car seat 10 includes an outer protective shell 20, an inner seat 30, and a suspension system 40. The car seat 10 also includes a harness (not shown) attached to the inner seat 30 for securing a child to the inner seat 30. The harness may directly attach to the inner seat 30, but is not directly attached to the outer protective shell 20. Further details of harnesses which can be used with the car seat 10 are described in greater detail below.

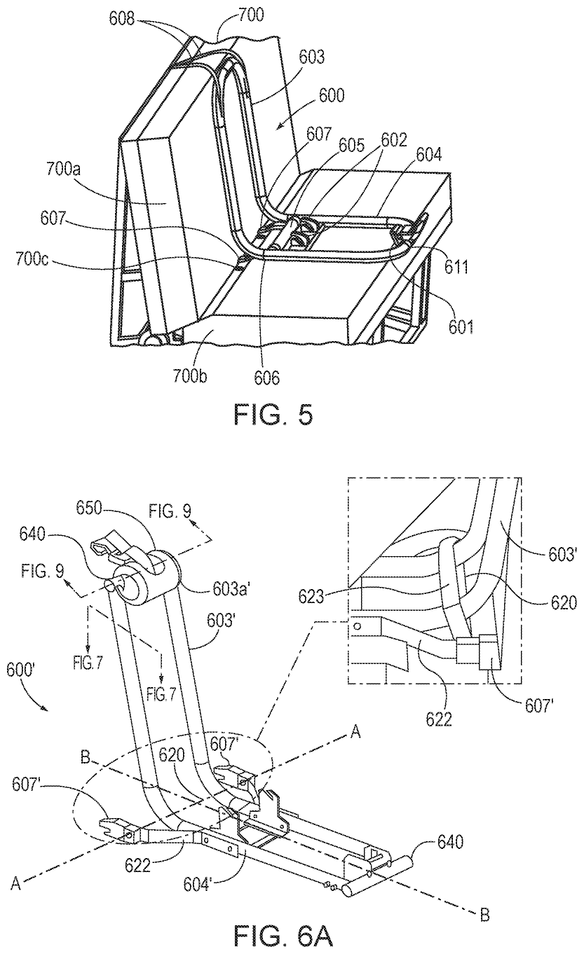

The inner seat 30 is connected to the protective shell 20 by the suspension system 40 such that the inner seat can move (float) a small amount (omnidirectionally) relative to the protective shell 20 as described below. Thus, the outer shell 20 provides support for the seat 30 (via the suspension system 40) but is not rigidly attached thereto. The outer protective shell 20 is adapted as described below to be coupled to a car seat mounting frame 600 (shown, for example, in FIG. 5, and described in greater detail below) that may itself be coupled to a vehicle seat 700.

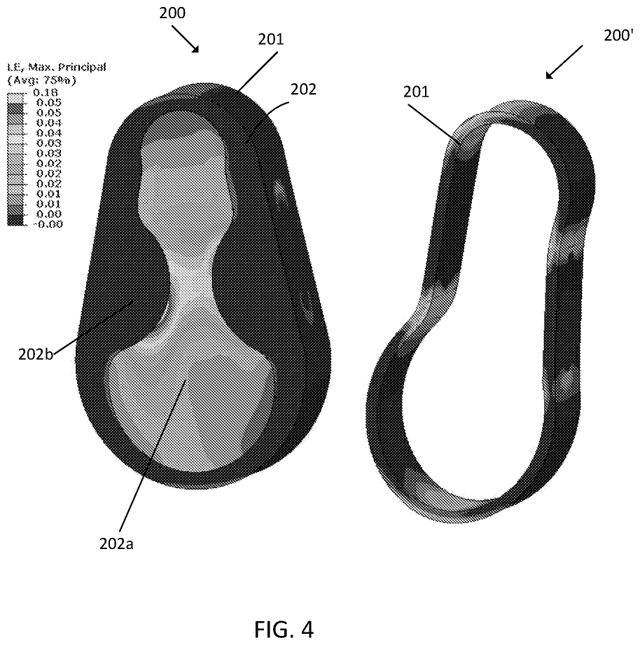

In one embodiment, the outer protective shell or frame 20 is made from a strong, light material such as carbon fiber or an aramid fiber such as KEVLAR (a trademark of DuPont, Wilmington, Del.), or any other strong, light material. In one embodiment, the shell 20 is constructed of multiple layers of carbon fiber, aramid fiber or a composite material. In another embodiment, the outer protective shell is formed from two separated layers of carbon fiber, aramid fiber or composite material (as seen, e.g., in FIG. 4) sandwiching a honeycomb, foam, or corrugated material (not shown). In other embodiments, the shell 20 is constructed of one or more of polycarbonate, polypropylene, ABS resin, and fiberglass. One function of the shell 20 is to provide support for the seat 30 via the suspension system 40. Another function of the shell 20 is to provide protection from intrusion by exterior objects.

In one embodiment the shell 20 provides side and back walls 20a-20c and a front wall 20d that connects the side walls 20a, 20b at the front of the car seat. The back wall 20c provides a high back compared to the front wall 20d, which is low. The side walls are contoured to extend from the back to the front. The front, back and side walls provide an upper edge 21 to which or over which a seat cover may be attached as described hereinafter. All walls may be rounded to eliminate edges so there may be no exact delineation of the front, side, and back walls.

Shell 20 also defines a series of attachment points for attaching straps (bands) 40a-40h of the suspension system 40. In the embodiment shown in FIG. 1, eight attachment points 24a-24h are defined on the inner side of the outer shell 20, including two attachment points 24a, 24b towards the top of side walls 20a, 20b, two attachment points 24c, 24d toward the bottom of the side walls 20a, 20b, two attachment points 24e, 24f in the bottom of the front wall 20d of the car seat, and two attachment points 24g, 24h at the top of the back wall 20c. In the embodiment shown in FIG. 1, all of the straps 40a-40h are formed as continuous bands. Each band 40a-40h is attached to a respective one of the eight attachment points 24a-24h. In at least one embodiment, a certain length of each band 40a-40h may be in contact with the attachment points 24a-24h. The bands 40a-40h may be attached to the outer protective shell 20 with fasteners, such as rivets, at the respective attachment points 24a-24h.

Also, the bands 40a-40h are attached to respective attachment points 30a-30h located on the outer surface of the inner seat 30. The bands 40a-40h may be attached to the inner seat 30 with fasteners, such as rivets, at the respective attachment points 30a-30h. Thus, when each band 40a-40h is connected between the inner seat 30 and the outer shell 20, each band 40a-40h is connected at two locations: an attachment point on the inner seat 30; and an attachment point on the outer protective shell 20. The continuous banded configuration of each band 40a-40h may allow each band to act like a spring. In one embodiment the bands 40a-40h may be formed of metals including aluminum and stainless steel. In one embodiment, one or more of the bands 40a-40h may be formed one or more of plastic, carbon fiber, and composite.

The outer dimensions of the shell 20 may vary widely. The shell 20 may be between 40 and 70 cm wide, or even narrower or wider, and between 20 and 60 cm deep, or even shallower or deeper, and between 50 and 80 cm high, or even shorter or taller. In one exemplary embodiment the outer dimensions of the shell is 50 cm wide (plus or minus 5 cm), 28 cm deep (plus or minus 3 cm), and 68 cm high (plus or minus 7 cm).

The inner seat 30 is scooped in shape and has a generally unitary (i.e., one piece) construction with a relatively high back, a deep seat area (for the buttocks), and a slightly rising surface for the thighs and legs. In one embodiment, the inner seat 30 is a protective seat made from a multi-layered construction, which overall remains a unitary structure. In one embodiment the inner seat includes a flexible hard outer shell layer, a cushioning spacer layer, and uniform foam layer, and an attached fabric or leather layer. The cushioning spacer layer neither covers the entire inside of the hard outer shell layer, nor the entire outside of the uniform foam layer. The fabric or leather layer can extend beyond the inner seat and attaches to the edge 21 of the shell 20 but does not inhibit seat 30 from moving relative to the shell 20. In another embodiment the multi-layered construction of the inner seat includes (from outside to inside) a hard outer shell layer, a cushioning spacer layer, and a uniform foam layer. An optional plastic, leather, or fabric layer (not shown) may be provided over the foam layer. A separate removable seat cover can be provided that extends over the seat 30 and attaches to the edge 21 of the shell 20. Again, the separate removable seat cover would not inhibit seat 30 from moving relative to the shell 20. The inner seat construction may be arranged to redirect energy transmitted from the outer shell along a circuitous path so as to absorb the energy.

All dimensions of the inner seat 30 are generally chosen to be smaller than the dimensions of the shell 20. Thus, inner seat 30 is suspended substantially within the shell 20 and generally protected by the shell 20. Moreover, the dimensions of the inner seat 30 are selected so that the inner seat 30 will remain within the shell 20 at all times, even during relative movement between the inner seat 30 and the shell 20.

The construction of the inner seat 30 and the outer shell 20 may be the same as described in co-owned U.S. patent application Ser. No. 13/785,555, filed Mar. 5, 2013, the entire contents of which are incorporated by reference as if set forth herein in their entirety.

The suspension system 40 functions to suspend the inner seat 30 relative to the outer shell 20 and to thereby act as a shock absorber/isolator between the shell 20 and the seat 30. In one embodiment, the suspension system 40 is an eight point suspension system with eight straps 40a-40h. Some or all of the straps 40a-40h may be the same length or size.

The embodiment of the car seat 10 described with reference FIG. 1 provides a highly protective, safe, and strong car seat system. In particular, because of the suspension system 40, in case the car in which the car seat 10 is anchored is in an accident that causes sudden acceleration and/or deceleration of the car, force that is applied to the shell 20 which is coupled to the car is not completely transferred to the inner seat 30 and is therefore not completely applied to the occupant of the seat 10. More particularly, in the case of an accident, regardless of the direction in which the seat 10 is facing and regardless of whether the result is a sudden acceleration and/or deceleration, the inner seat 30 may move inside the shell, and the suspension system 40 may absorb some, much, or all of the energy. The inner seat 30 will swing inside the shell 20 to the extent allowed by the deformation of the straps 40a-40h of the suspension system 40 (it being appreciated that the fabric or leather covering will easily comply). The inner seat 30 may move in any direction relative to the shell 20, including front-to-back and side-to-side. Thus, if the impact is severe enough, the energy imparted to the straps 40a-40h may cause the straps to elastically and/or permanently deform, in which case the inner seat 30 may translate in addition to swing. More specifically, during a collision, the inner seat 30 can push one or more of the straps 40a-40h against the outer shell 20 so as to bring the attachment points 24a-24h and 30a-30h towards each other. Also, the inner seat 30 can pull on the straps 40a-40h so as to move the attachments points 24a-24h away from each other. In either case, the straps 40a-40h may act like springs that may absorb energy by deforming in response to forces imparted by relative movement between the inner seat 30 and the outer protective shell 20. Moreover, the energy imparted to the straps 40a-40h can be stored as potential energy during an impact and, if the straps are not permanently deformed, the straps 40a-40h can convert that potential energy into kinetic energy so that the straps 40a-40h recoil towards their undeformed, initial position shown in FIG. 1.

Some, most, or all of the energy that is transferred from the shell 20 to the inner seat 30 will be absorbed by the seat 10 itself rather than transferred to the occupant of the seat. Furthermore, should the accident cause dislocation of the interior of the car or should an object hit the shell of the car seat, the shell 20 is of extremely high strength and will remain structurally intact in almost all circumstances. Thus, the occupant of the car seat 10 will not be crushed and will be protected by the foam padding of the seat 10. Further yet, it should be appreciated that the described car seat system will be light in weight (e.g., under 4 kg; and possibly around 3 kg).

FIG. 2 illustrates one embodiment of a suspension element 200 that can substitute for one or more of the straps 40a-40h of the suspension system 40 in FIG. 1. The suspension element 200 includes a plastically deformable outer suspension band 201 surrounding a plastically deformable insert 202, which, in FIG. 2, is configured to completely fill the space 203 surrounded by the band 201 and be retained therein when the suspension element 200 is fully assembled. In one embodiment, the insert 202 may not completely fill the space 203, but instead may itself define open spaces, holes, or voids therein. The suspension band 201 may be the same as a respective one of the straps 40a-40h described above and may be configured to connect the inner seat 30 to the outer shell 20 as described above with respect to the seat 10 in FIG. 1. In one embodiment, the suspension band 201 is formed of aluminum (Grade 6061-T6) and has a wall thickness, t, of 2 mm. In other embodiments, the suspension band 201 may be formed of other metals or plastics which are plastically deformable. The suspension element 200 has a planar front side (shown in FIG. 2) and planar rear side (not shown in FIG. 2) that is identical to the front side. In the embodiment shown, the band 201 and the insert 202 have the same thickness between the front side and the back side of the suspension element 200, though such relative dimensions are not a requirement.

Owing to the insert 202 being surrounded by the band 201, if the band 201 deforms (is compressed and buckles) within the plane of the suspension element 200 as a result of relative movement between the inner seat 30 and the outer shell 20 (e.g., during a vehicle impact), the insert 202 can also compress to aid in absorbing some of the energy and resist complete collapse of the band 201.

The insert 202 may be comprised of one material or a plurality of different materials forming a composite structure, such as the one shown in FIG. 2. In the embodiment shown in FIG. 2, the insert 202 includes an inner filler material 202a and an outer filler material 202b that surrounds the inner filler material 202a. The inner filler material 202a may be more compressible than the outer filler material 202b. For example, in the embodiment described herein, the inner filler material 202a includes a crushable foam (viscoelatic or viscoplastic) and the outer filler material 202b includes a short glass fiber filled injection molded polymer (Grade 70G33L). Though the insert 202 is shown in FIG. 2 as being a fully solid member, this is not a requirement. For example, the insert 202 may also include a plastically deformable honeycomb, lattice, or mesh structure (with hollow cellular openings) formed of metal (e.g., aluminum) or plastic.

The inner filler material 202a is shaped having indented sides 202a′ that conform to and align with inner inwardly directed protrusions 202b′ formed in the outer filler material 202b. The indents 202a′ and the protrusions 202b′ can provide a safety limit on the amount of deformation (buckling) that the band 201 and the outer filler material 202b can undergo. For example, if the load transmitted to the suspension element 200 is high enough, the outer filler material 202b will compress such that the protrusions 202b′ contact one another and compress against each other and will not allow further collapse of the band 201. Therefore, owing to the properties and structure of the insert 202, the suspension element 200 will not be able to fail in collapse like the banded straps 40a-40h.

In the embodiment shown, the band 201 has a wider diameter section 201a (lower section in FIG. 2) and a narrower diameter section 201b (upper section in FIG. 2), such that the walls of the sides of the band 201 are not parallel, but instead are tapered towards each other at a non-zero angle. The inner filler material 202a has a head 202i in the narrower diameter section 201b of the band 201, a narrow neck 202ii, and a rounded torso 202iii in the wider diameter section 201a of the band 201.

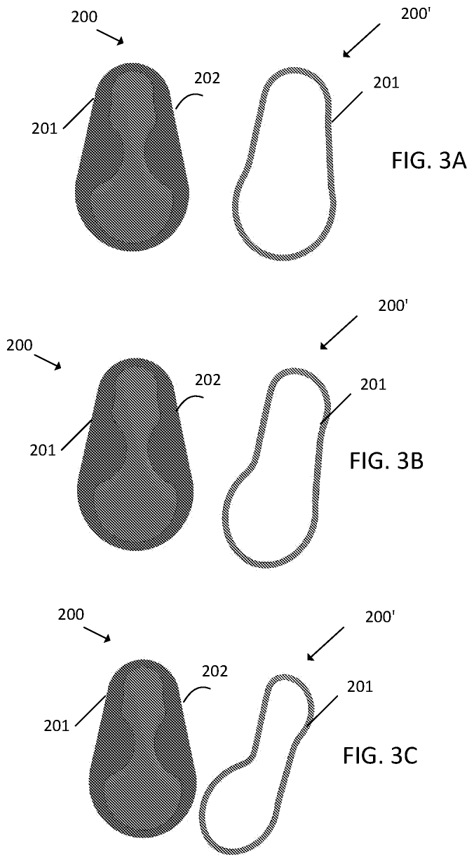

FIGS. 3A to 3C illustrate progressive stages of deformation of the suspension element 200 (shown on the left in each of FIGS. 3A to 3C) according to a modeled impact force being imparted to the suspension element 200, beginning with an initial undeformed, relaxed state of the suspension element 200 (FIG. 3A), to an intermediate deformed state of the suspension element 200 (FIG. 3B), to a final deformed state of the suspension element 200 (FIG. 3C). In each of FIGS. 3A to 3C, the suspension element 200 is shown alongside (on the right), for comparative purposes, with a suspension element 200′ that only includes the band 201 (i.e., the insert 202 is not used). In each of FIGS. 3A to 3C, the suspension elements 200 and 200′ are modeled as receiving the same forces. As shown in FIGS. 3A to 3C, the deformation of the suspension element 200 remains relatively small throughout the stages of deformation in comparison to the deformation of the suspension element 200′, avoiding a complete failure of the suspension element 200.

FIG. 4 shows additional results of an experimental model that maps load level throughout the suspension elements 200 and 200′ of FIGS. 3A to 3C at the final deformed state of (FIG. 3C). At that state, the outer filler material 202b and the band 201 have relatively small deformation and does not experience failure. Also, strains on the outer filler material 202b are well within safe limits (below 5%) while the inner filler material 202a experiences about 20% strains. These modeled results indicate that the inner filler material 202a contributes to absorbing impact energy along with the band 201 and the outer filler material 202b. It will also be appreciated that in addition to absorbing impact energy, the inner filler material 202a can serve as a vibration dampener to the inner shell 30.

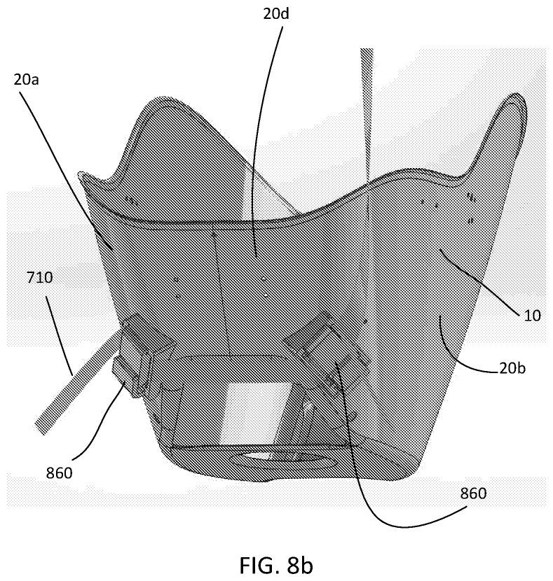

FIG. 5 shows a frame 600 that can be used to connect the car seat 10 of FIG. 1 to a vehicle seat 700. The frame 600 is the same frame shown in FIG. 8 of co-owned U.S. Patent Application Publication No. 2016/0332542. The frame 600, includes a substantially vertical (within about 25 degrees of vertical) portion 603 and a substantially horizontal (within about 25 degrees of horizontal) portion 604, which extend from one another at a fixed angle. In one embodiment, the angle is approximately 97 degrees (it being noted that the term “approximately” as used herein in the specification and claims with respect to angles includes plus or minus 3 degrees). In the embodiment shown in FIG. 5 the vertical portion 603 and the horizontal portion 604 are both generally u-shaped members having the same width. The connection of the frame 600 to the car seat 10 is described in co-owned U.S. Patent Application Publication No. 2016/0332542, the entire contents of which are incorporated herein.

The frame 600 may be formed of metal, such as aluminum. Of course, in other embodiment, the frame may be formed of other metals, such as titanium and steel, or non-metals, such as carbon fiber and plastic. Also, the horizontal and vertical portions 604 and 603 may be hollow or may be solid. For example, in one embodiment, the horizontal and vertical portions 604 and 603 are formed of tubular aluminum having a wall thickness of about 2 mm and an outer diameter of about 31.75 mm. It should be appreciated that for purposes herein, the term “tubular” does not require that a cross-section be round, as the tubular element may take any of many shapes.

The horizontal portion 604 has a cross bar 605 at a proximal end 606 of the horizontal portion 604. A pair of connectors 607, such as mini-connectors, extends from the cross bar 605. The connectors 607 are free to rotate with the cross bar 605. The connectors 607 are constructed to couple to LATCH anchors 700c of the vehicle seat 700, which are located in the bight of the seat 700. In one embodiment, the vertical and horizontal portions 603 and 604, and cross bar 605 are formed of a metal, such as aluminum, and may be solid or tubular in form. The width between the connectors 607 is about the same as the width of the horizontal portion 604. The width between the connectors 607 is chosen to be about the standard width of vehicle LATCH tethers of the vehicle seat, which are about 11 inches apart.

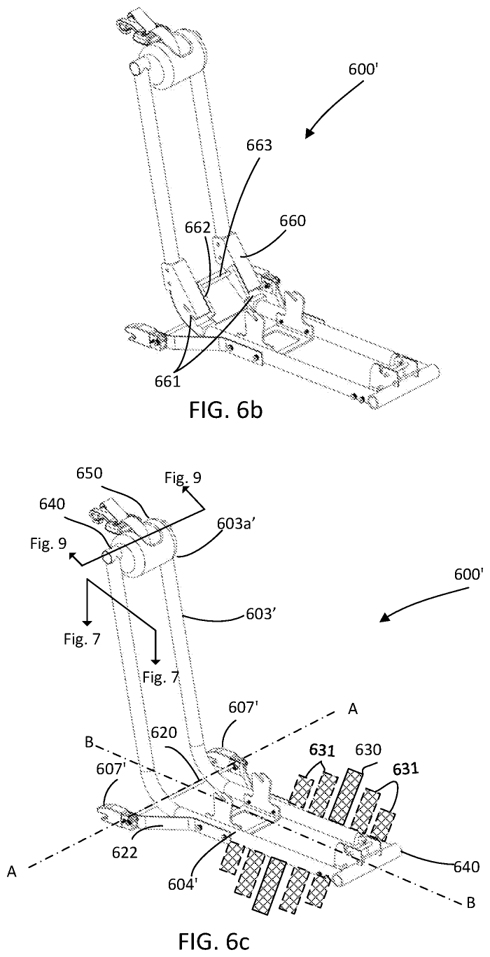

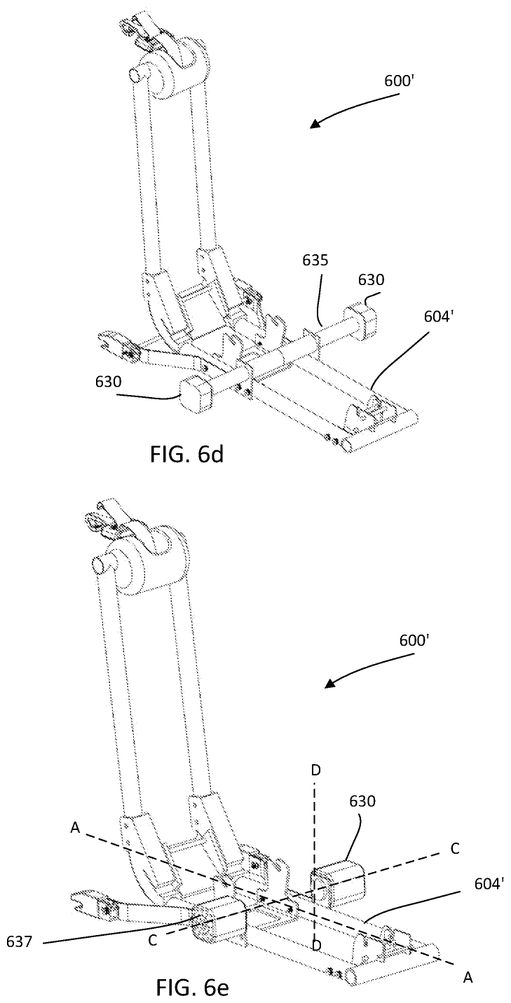

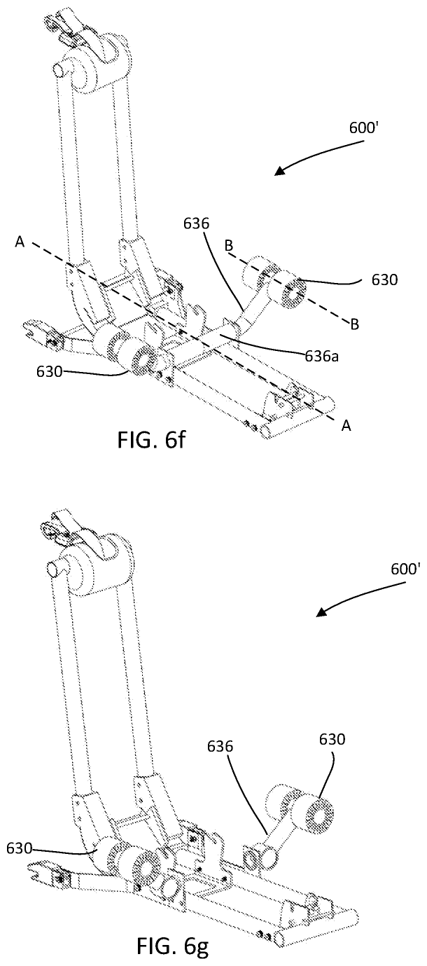

FIG. 6a illustrates an alternative frame 600′ to frame 600 where like elements to those in FIG. 5 are appended with a prime indicator (′) The frame 600′ has a narrower horizontal portion 604′ and narrower vertical portion 603′ than the corresponding portions of frame 600, but retains connectors 607′ at the same width as in frame 600. In one embodiment, the width of the horizontal and vertical portions 604′ and 603′ are reduced from 11 inches to 6 inches. Specifically, frame 600′ has a pair of connectors 607′ that preferably remain spaced about equal to the width of the LATCH tethers of the vehicle seat (e.g., about 11 inches). The connectors 607′ are connected to each other by an elongated rod 620 that extends across the width of the horizontal and vertical portions 604′ and 603′. The connectors 607′ remain free to pivot about an axis A-A extending through the elongated rod 620. For example, when the connectors 607′ are not intended to be used to connect the frame 600′ to the vehicle seat (e.g., when vehicle seatbelts are used, as described below), the connectors 607′ can be rotated out of the way, such as 180 degrees with respect to the position shown in FIG. 6a, so that they do not interfere with locating the frame 600′ against the vehicle seat. Also, in one embodiment, the rotational position of the connectors 607′ with respect to axis A-A can be locked in place with a suitable locking mechanism, such as when the connectors 607′ are to be used to connect the frame 600′ to corresponding mating connectors 700c of the vehicle seat (e.g., LATCH anchors). This can be helpful to when the LATCH anchors 700c are located above or below a plane of the horizontal portion 604′ of the frame 600′. In such case, the connectors 607′ can be rotated 607′ about axis A-A into alignment with the corresponding LATCH anchor 700c and rotationally locked into position to prevent the frame 600′ from freely rotating about axis A-A.

Also, each connector 607′ is supported by a respective lateral member 622 extending diagonally outwardly from the horizontal portion 604′ to the connector 607′. Each lateral member 622 fixes the position of the connector 607′ with respect to the horizontal and vertical members 604′ and 603′. Each lateral member 622 extends outward from the horizontal portion 604′ as a lever arm about axis B-B and functions to counteract torque that may be exerted on the frame 600′ in the event of a side impact to the vehicle. Thus, the lateral members 622 can enhance the torsional stability of the frame 600′ when it is connected to the vehicle seat 700 using the connectors 607′.

Optionally, as shown in the exploded detail in FIG. 6a, a strap 623 may extend between the connectors 607′ over and across the horizontal and vertical members 604′ and 603′. The optional strap 623 can provide additional stability to the frame 600′ and the lateral members 622.

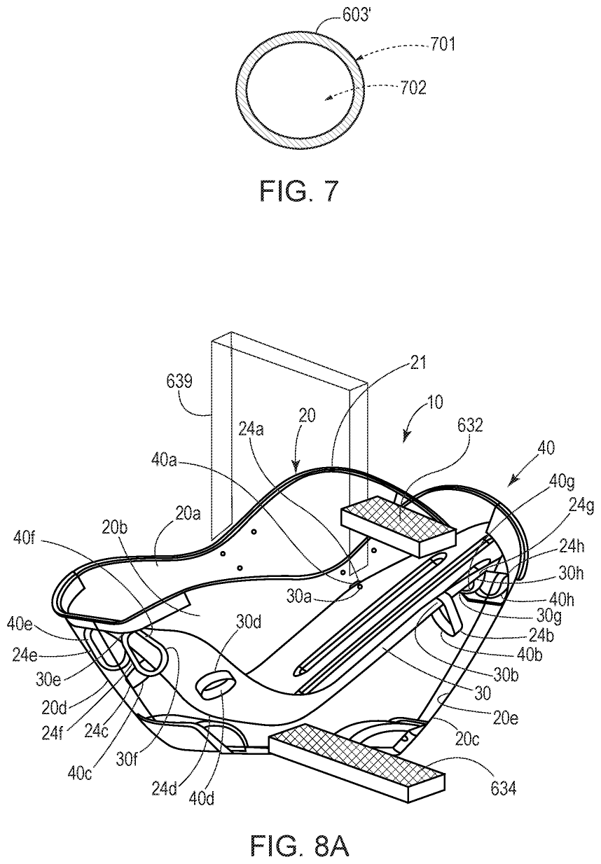

Like frame 600, the horizontal and vertical portions 604′ and 603′ of the frame 600′ may be formed as hollow or solid tubular members. In a case where the horizontal and vertical portions 604′ and 603′ are formed as hollow members made of a first material, either of the hollow interiors may optionally be filled with a second, different material. For example, FIG. 7 shows a view through the vertical portion 603′ which includes an annular wall of tubing 701 (which may be made of steel or aluminum, for example) surrounding a core 702 (which may be formed of expanded polyurethane (EPS) foam). The inner core 702 reinforces the tubing 701 and increases shear and buckling stiffness, which can allow the filled frame portion 603′ to absorb more energy during bending. Moreover, incorporating the foam core 702 into the tubing 701 may permit the use of thinner walled tubing 701 for the vertical portion 603′ due to the added stiffness and strength. Such reductions in wall thickness may, consequently, reduce the weight and cost of the frame 600′. It will be appreciated that while the foam core 702 fills the entire hollow area in the tubing 701, this is not a requirement. Indeed, the core 702 may have various sectional shapes (e.g., star, X-shape) which may leave spaces or openings in the interior of the tubing 701.

FIG. 6b shows the frame 600′ with an optional seatbelt lockoff 660. The frame 600′ may be configured to be connected to a vehicle seat (e.g. seat 700, FIG. 5) either by mini-connectors 607′ or by vehicle seatbelt straps (not shown) that are part of the vehicle. Vehicle seatbelt straps may be used for the connection of the frame 600′ in vehicles that do not have LATCH anchors. As shown in FIG. 6b, the lockoff 660 defines belt slots 661 that are configured to receive and route a lap belt of a vehicle seatbelt (not shown) horizontally across the lockoff 660. A pivotally connected lap belt clamp 662 pivots about rod 663 to open (away from the belt pathway) and close (toward and/or into the belt pathway, as shown in FIG. 6b). As shown in FIG. 6b, when the clamp 662 is in the closed position, it partially occludes the belt pathway in a manner that will pinching any lap belt in the clamp when the clamp 662 is in the closed position. During use, a user that connects the frame 600′ to the vehicle seat using the lockoff 660 may position the frame 600′ on the vehicle seat in the desired location and open the clamp 662 by rotating it upward away from the belt slots 661. Then, a user may draw the lap belt of the vehicle seatbelt through both belt slots 661 and pull the belt taught in the slots 661 to remove slack in the belt. When the lap belt is tightened the clamp 662 can be rotated back down onto the belt so that the clamp 662 assumes its closed configuration shown in FIG. 6b. The surfaces of the clamp 662 that are configured to contact the belt may have non-slip texture to grip the belt to further limit relative movement between the clamp 662 and the belt. In one embodiment, when the car seat (e.g., car seat 10) is connected to the frame 600′, the outer surface of the car seat may bear against or be spaced in close proximity to the clamp 662 to prevent the clamp 662 from rotating out of the closed position shown in FIG. 6b. Thus, in at least one embodiment, the clamp 662 can only be adjusted when the car seat is disconnected from the frame 600′.

Optionally, as shown in FIGS. 6c to 6g, the frame 600′ may have at least one plastically deformable side impact energy absorbing element 630 connected to the sides of the frame 600′. As shown in FIG. 6c, the energy absorbing element 630 is shown extending laterally (i.e., outwardly with respect to the axis B-B) from the horizontal portion 604′ of the frame 600′. The energy absorbing element 630 can alternatively or additionally extend from the upper portion 603′ of the frame 600′. The energy absorbing elements 630 can be made wider or, optionally, a plurality of discrete energy absorbing elements 631 can be placed side-by-side (either in spaced relation as shown in FIG. 6, or adjacent one another) and extend laterally from the horizontal or vertical portions 604′, 603′ of the frame 600′.

The energy absorbing elements 630 and 631 are preferably comprised of a plastically deformable material(s) which can absorb energy as a result of plastic deformation. Thus, upon the energy absorbing elements 630 and 631 receiving at least a certain side impact force, the energy absorbing material of those elements will begin to plastically deform (e.g., will be crushed), which can reduce the energy transferred through the frame 600′ to the occupant of the car seat when it is connected to the frame 600′. In one embodiment, the energy absorbing material of the energy absorbing elements 630 and 631 has a lattice or honeycomb structure and may be made of metal or plastic. Examples of honeycomb structures that may be used include the various HexWeb® honeycomb materials available from Hexcel Corporation of Stamford, Conn. The honeycomb structure can be arranged so that the honeycomb pattern extends vertically, as shown for example in FIG. 8a.

The laterally extending energy absorbing elements 630 and 631 are configured to extend beyond a side wall of a car seat (e.g., car seat 10) when the car seat is connected to the frame 600′. This staggered arrangement permits the energy absorbing elements 630 and 631 to engage an impinging object (e.g., vehicle side door panel) before the side wall of the car seat in the event of a side impact collision of the vehicle. This will allow the energy absorbing elements 630 and 631 to plastically deform and absorb some of the energy of the side impact and thereby reduce energy transmitted to the car seat (e.g., car seat 10) and, therefore, to the occupant of the car seat.

In one embodiment, one or more of the energy absorbing elements 630 and 631 are configured to telescopically adjust in length. Also, in one embodiment, one or more of the energy absorbing elements 630 and 631 is configured to fold against the tubular frame 600′ into a stowed configuration to facilitate storage and transport of the frame 600′ before installation. This may be accomplished by use of a suitable hinge arrangement between the frame 600′ and the energy absorbing elements 630 and 631. If so configured to fold in a stowed configuration, one or more of the energy absorbing elements 630 and 631 can be subsequently rotated outwardly from the stowed configuration into the deployed configuration shown in FIG. 6 upon connection of the frame 600′ to the vehicle seat 700 (FIG. 5).

FIG. 6d shows an alternate arrangement of frame 600′ and energy absorbing elements 630 from that shown in FIG. 6c, in which the energy absorbing elements 630 are disposed at an end of a laterally extending rod 635, which may be telescopically extendable and retractable or foldable as discussed above and attached to the frame 600′ by suitable mounting (e.g., brackets, welding). Although the rod 635 is shown as extending across the horizontal portion 604′ of the frame 600′, the rod 635 need not extend across that space. For example, FIG. 6e shows another arrangement of frame 600′ and energy absorbing elements 630 from that shown in FIG. 6d, where the rod 635 is omitted across the horizontal portion 604′ of the frame 600′ and is omitted between the frame 600′ and the energy absorbing elements 630. In the example shown in FIG. 6e, the energy absorbing elements 630 are longer along axis c-c than those elements 630 shown in FIG. 6d so that the elements 630 in FIG. 6e extend laterally outwardly from the horizontal portion of the frame 604′ instead of from the rod 635. Also, the energy absorbers 630 in FIG. 6e may have an exposed honeycomb structure 637 with cells extending in alignment with axis c-c. It will be appreciated however, that in other alternative arrangements the energy absorber 630 may be mounted to the frame 600′ so that the cells of such a honeycomb structure 637 extend transverse to axis c-c (e.g., align with a vertical axis d-d or horizontal axis a-a, shown in FIG. 6e) to achieve, for example, a different energy absorption characteristic.

FIG. 6f shows another alternate arrangement of frame 600′ with energy absorbing elements 630 that are attached to rods 636, which extend laterally and upwardly (with respect to a plane of the horizontal portion 604′ of the frame). In the embodiment shown in FIG. 6f, the energy absorbing elements are formed as cylinders having a major axis B-B extending substantially parallel (=/−10 degrees) with axis A-A through the center of the horizontal portion 604′ of the frame 600′. If the energy absorbing elements 630 include a honeycomb material, the cells may extend along axis B-B as well, or may extend annularly (as rings) around axis B-B, or may extend radially outwardly from axis B-B. When a car seat (e.g., car seat 10) is connected to the frame 600′, the energy absorbing elements 630 are configured to be positioned proximate the outside sidewalls of the car seat so that the energy absorbing elements 630 can be used to provide additional side-impact protection for the car seat against objects that may encroach into the vehicle cabin (during a side impact collision) at a height above the horizontal portion 604′ of the frame 600′. As shown in FIG. 6f, rods 636 connect together through a central, horizontal portion 636a that extends across the horizontal portion 604′ of the frame 600′. FIG. 6g shows another example of a frame 600′ to that shown in FIG. 6f, where portion 636a of rods 636 is omitted.

As shown in FIG. 8a, as an addition or alternative to the energy absorbing elements 630 and 631 attached to the frame 600′, the car seat 10 itself may also include at least one of side impact energy absorbing elements 632 and 634, which can have the same or different construction as energy absorbing elements 630 and 631 described above. Energy absorbing element 632 is connected to and extends laterally (outwardly) from a handle 639, which is connected to the car seat 10 across the side walls 20a, 20b of the car seat outer shell 20. Energy absorbing element 634 is connected to and extends laterally (outwardly) from the side walls 20a, 20b of the car seat outer shell 20. The energy absorbing elements 632 and 634 function in the same manner to dissipate energy from a side impact.

FIG. 8b shows the car seat 10 with optional seatbelt lockoff clamps 860 attached to front 20d and sides 20a and 20b of outer shell 20. The car seat 10 may be configured to connect to a vehicle seat (e.g. seat 700, FIG. 5) by vehicle seatbelt straps 710 (FIG. 8b) that are part of the vehicle and without use of the frame 600′. Vehicle seatbelt straps 710 may be used for the connection of the car seat 10 in vehicles that do not have a frame 600′, such as a rented car or a taxi. As shown in FIG. 8b, the clamps 860 are configured to route the vehicle lap belt 710 through the clamps 860 and across the front side 20d of the outer shell 20. Also, the clamps 860 are configured to securely fasten to the routed lap belt 710 once the car seat 10 is suitably positioned on the vehicle seat 700. The clamps 860 are configured to securely retain the belt 710 and limit relative movement between the belt 710 and the clamps 860 when the clamps 860 are closed. Once the lap belt 710 is in the clamps 860 and the clamps 860 are closed, the clamps 860 resist relative lateral movement between the belt and the clamps 860.

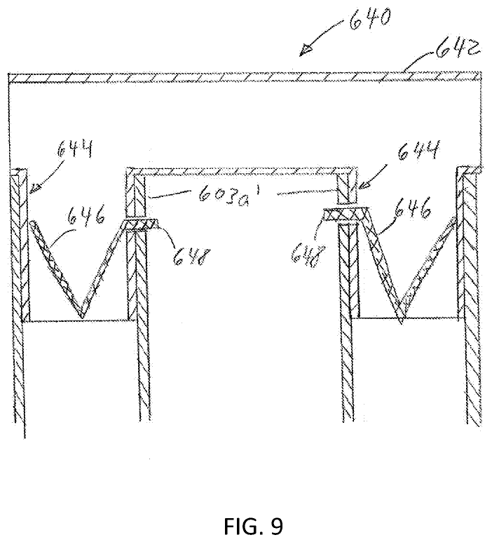

Turning back to FIG. 6, ends 603a′ of the tubular vertical portion 603′ may be joined by a cap 640, which may be made of metal or, preferably, plastic, to save weight. As shown in greater detail in FIG. 9, the cap 640 includes a horizontal member 642 and vertical legs 644 that extend from the horizontal member 642. The legs 644 are configured to be received in the tubular ends 603a′ of the vertical portion 603′ of the frame 600′. Each leg 644 may have a snap fit connector 646, such as a spring loaded pin clip. The connector 646 has a pin 648 that locks the leg 644 to the vertical portion 603′ of the frame 600′ when aligned with a hole 603b′ defined in the vertical portion 603′ of the frame 603′. The tubular horizontal and vertical portions 604′ and 603′ of the frame 600′ can be filled with the afore-mentioned EPS foam through openings at the ends 603a′ when the cap 640 is not connected to the frame 600′. Tubular ends of the horizontal portion 604′ of the frame 600′ may be joined by another cap 640 (FIG. 6) in like manner to the arrangement just described.

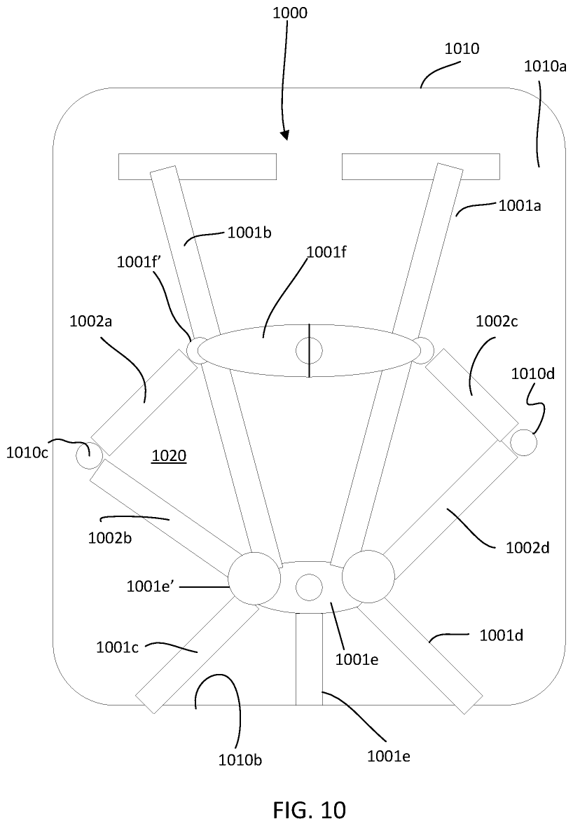

FIG. 10 shows a schematic view of a harness system 1000 for an inner seat 1010 of a car seat in accordance with another aspect of the disclosure. The harness system 1000 is shown in a fully closed configuration, such as when an occupant of the inner seat 1010 is fully secured thereby. FIG. 10 shows a seat back 1010a and seat bottom 1010b of the inner seat 1010, which can be a substitute for inner seat 30 of car seat 10. The harness system 1000 includes a five point harness 1001 and a plurality of side bolster straps 1002a, 1002b, 1002c, and 1002d, such that the harness system 1000 can be considered a nine-point harness. The five point harness 1001 includes shoulder straps 1001a and 1001b, thigh straps 1001c and 1001d, crotch strap 1001e, chest buckle 1001f, and crotch buckle 1001g. The five point harness 1001 can be constructed as is known in the art.

The chest buckle 1001f connects the shoulder straps 1001b and 1001a together at a vertical position spaced above the crotch buckle 1001e. The left straps 1002a and 1002b are symmetrical with the right straps 1002c and 1002d and the following description will be with respect to the left straps but is equally applicable to the right straps. Strap 1002a is connected to a connection point 1001f′ on the left half of chest buckle 1001f and a connection point 1010c to the seatback 1010a. Strap 1002b is connected to a connection point 1001e′ on or at the crotch buckle 1001e and to the connection point 1010c of the seatback 1010a. The connection point 1001e′ can be part of a connector that connects straps 1001b, 1001b, and 1001c together and to crotch buckle 1001e. The location 1010c (and also location 1010d on the right side) is spaced vertically between the chest buckle 1001f and the crotch buckle 1001e, and is spaced horizontally to the left of the chest buckle 1001f and the crotch buckle 1001e. It will be appreciated that the straps 1002a and 1002b may be formed as a single piece or two separate pieces. If the straps 1002a and 1002b are formed together as one piece, they may be routed through a loop at the location 1010c.

A triangular area 1020 is defined between the straps 1002a, 1002b, and 1001b. The triangular area 1020 can be covered by other straps, a mesh, or a solid panel connected between the straps 1002a, 1002b, and 1001b. The straps 1002a and 1002b may be adjustable in length with a strap adjuster (not shown) as is known in the art.

The bolster straps 1002a-1002d function to bolster the occupant in the five-point harness 1100 from side-to-side movement. It will be appreciated that as the occupant of the car seat 1010 grows, adjustment of the straps of the harness 1000 may be necessary. For example, as the child occupant of the car seat 1010 grows adjustment of the harness 1000 may cause the distance between the chest buckle 1001f and the crotch buckle 1001e to increase. Because the straps 1002a and 100b are connectable to the chest buckle 1001f and the crotch buckle 1001e, the triangular area 1020 will expand automatically to maintain side impact support of the occupant of the seat 1010.

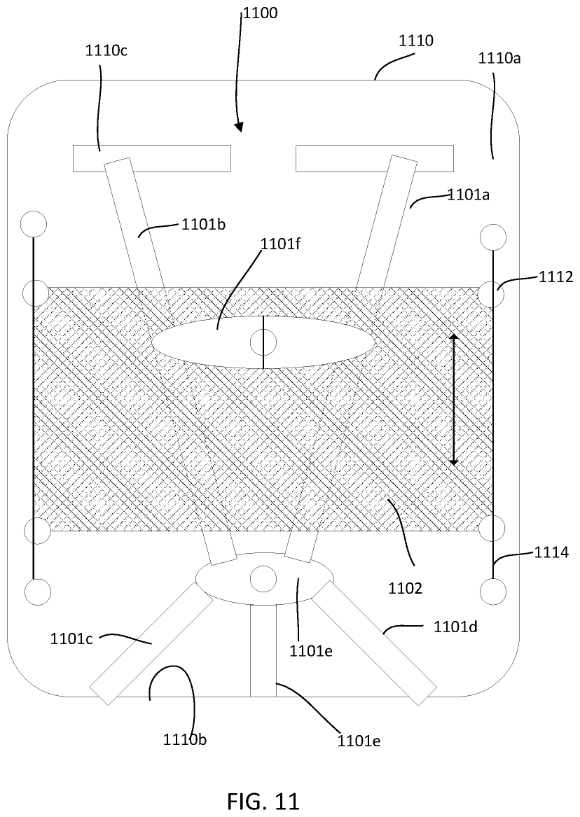

FIG. 11 shows a schematic view of a harness system 1100 for an inner seat 1110 of a car seat in accordance with an aspect of the disclosure. The harness system 1100 is shown in a fully closed configuration, such as when an occupant of the inner seat 1110 is fully secured thereby. FIG. 11 shows a seat back 1110a and seat bottom 1110b of an inner seat 1110, which can be a substitute for inner seat 30 of car seat 10. The harness system 1100 includes a five point harness 1101 and a side bolster panel 1102, such that the harness system 1100 can be considered a six-point harness. The five point harness 1101 includes shoulder straps 1101a and 1101b, thigh straps 1101c and 1101d, crotch strap 1101e, chest buckle 1101f, and crotch buckle 1101g. The five point harness 1101 can be constructed as is known in the art.

The panel 1102 is configured to extend over the five point harness 1101 and across a torso area between the crotch buckle 1101e and the tops of the shoulder straps 1101b and 1101a (e.g., at shoulder strap slots 1110c defined in the seatback 1110a). Also, the panel 1102 is configured to be fully or partially removable from the seat 1110 so that a user has access to the five point harness 1101. In one embodiment, the panel 1102 is retained to the seatback 1110a on the right side (or left side) and is removably connected to the inner shell 30 on the left side (or right side) of the strap or panel 1102. In another embodiment, the panel 1102 is removably connected to the seatback 1110a on both sides of the panel 1102. As used herein, removable connections do not include connections that require cutting or breakage of parts or connections that would not permit ready reattachment upon disconnection without restoration to the connectors. Removable connections 1112 may include snaps, hooks and loops, toggles, and clips. The length (width) of the panel 1102 may be adjustable to fit different sized occupants of the seat 1110 such as by use of adjusting straps (not shown). The panel 1102 may be formed as a mesh with openings therein or be formed as a solid panel. The mesh or solid panel may be elastic or inelastic.

In one embodiment, the vertical position of the panel 1102 is adjustable so that it may be used with different sized occupants and not interfere with the head or neck of the occupant. In one embodiment, the aforementioned connections of the panel 1102 with the inner seat 1110 may be configured to permit the panel 1102 to move vertically once it is connected to the seatback 1110a on both sides of the panel 1102, or permit the panel 1102 to be fully or partially disconnected from the seat 1110 and repositioned and reattached in a lower or higher position as desired. For example, the seatback 1110a may define one or more vertical slots 1114 forming respective tracks in which the sides of the panel 1102, or connectors 1112 attached thereto, can be securely coupled to the seatback 1110a and allow the connected side of the panel 1102 to move vertically in the respective slot 1114. The vertical slots 1114, the panel 1102, or connectors 1112 can be configured to resist movement of the panel 1102 once it is vertically positioned relative to the seatback 1110a. For example, the vertical slot 1114 can be lined with a rubber or non-slip material such that it will grip the panel 1102 or the connectors 1112 in the slot so that the panel 1102 will not easily slide vertically once the panel 1102 is drawn over the harness 1101 and secured to the seat 1110 along both sides of the panel 1102.

In use, prior to placing an occupant into the inner seat 1110, the panel 1102 is either fully detached from the back panel 1110a or disconnected from the back panel 1110a along one side of the panel 1102 so that it can be drawn towards one side of the seat 1110. Also, prior to placing a child occupant into the inner seat 1110, the five point harness 1101 is fully opened, as is known in the art. Then, the occupant is seated in the inner seat 1110 and the five point harness 1101 is buckled over the child as known in the art. Then, the panel 1102 can be fully reattached to the back panel 1110a over the harness 1101, or the disconnected side of the panel 1102 drawn over the fully buckled five point harness 1101 and reconnected to the seatback 1110a with one or more connectors 1112. The panel 1102 functions to bolster or otherwise support the restrained occupant in the seat 1110 and limit side-to-side and front-to-back movement of the occupant relative to the inner seat 1110.

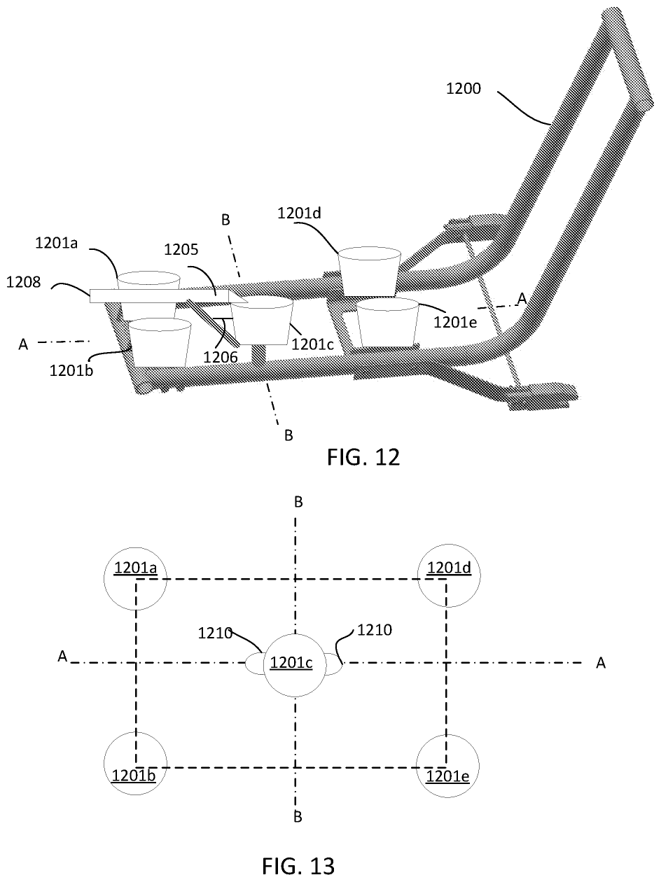

FIG. 12 shows another embodiment of the frame 600″ which incorporates a connection arrangement for connecting the frame 600″ to a car seat, such as car seat 10. The connection arrangement permits the car seat 10 to be connected only in two orientations: a forward facing (seat occupant facing towards the front of the vehicle and opposite the seatback) and a rear facing (seat occupant facing the seatback) orientation. Thus, a user of the car seat is restricted from connecting the car seat 10 to the frame 600″ in any other orientation, such as sideways. Further details of the connection arrangement will now be described.

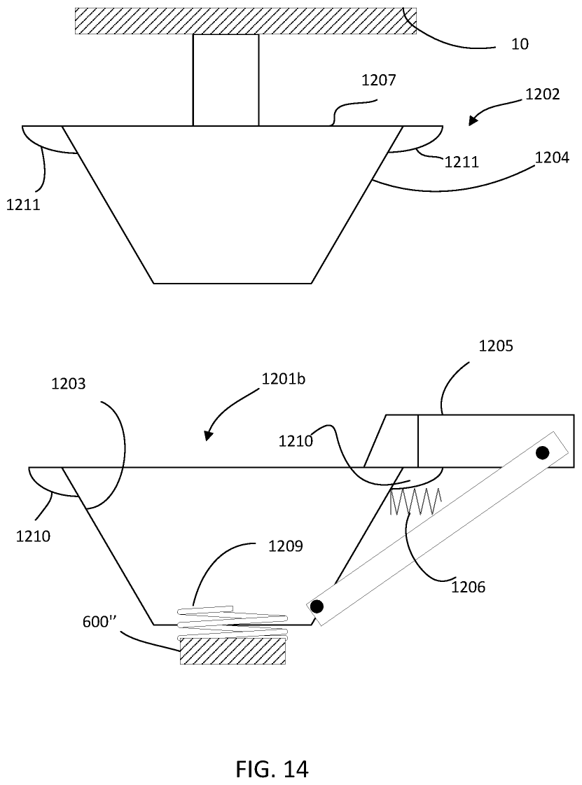

The frame 600″ has at least one female socket 1201 that is configured to receive a male projection 1202 (FIG. 14) extending from the bottom of the car seat 10. As shown in FIG. 13, five female sockets 1201a-1201e are included, with four sockets 1201a, 1201b, 1201d, and 1201e positioned at corners of a rectangle (shown in broken lines in FIG. 13) and one socket 1201c at the center of that rectangle. The rectangle has its longer dimension along axis A-A. Though not shown in FIG. 14, the male projections 1202 are arranged on the bottom of the car seat 10 in the same pattern of the sockets 1201 shown in FIG. 13 with the longer dimension of the rectangle aligned front to back of the bottom side of the car seat 10. Accordingly, the male projections 1202 can only align with the female sockets 1201 when the car seat 10 is facing forward or rearward along axis A-A with respect to the frame 600″. It will be appreciated that in one embodiment, the car seat 10 may have three male projections 1202 instead of five since the rectangular pattern of the sockets 1201 is symmetrical about axis B-B, which is transverse to axis A-A and passes centrally through the socket located in the center of the pattern shown in FIGS. 12 and 13. Thus, in one embodiment of the car seat 10, the three male projections 1202 align with sockets 1201c, 1201d, and 1201e when facing forward, and align with sockets 1201a, 1201b, and 1201c when facing rearward.

Moreover, in one embodiment, only a single socket 1201 may be provided with a keyed feature to ensure alignment of the seat 10 with the frame 600″ in one corresponding direction. For example, as shown in FIG. 13, the central socket 1201 may incorporate one or both of keyed features 1210, shown as rounded tabs. Such tabs 1210 may be rounded, squared, triangular, or irregular in shape. The tabs 1210 are configured to align with and mate to corresponding features 1211 (FIG. 14) on the bottom of the seat 10 so that the seat 10 can only be connected to the frame 600″ when the tabs 1210 and mating features of the car seat bottom align with one another.

FIG. 14 illustrates details of one embodiment of a central socket 1201c and a corresponding male projection 1202. Female socket 1201c has an inner surface 1203 that corresponds to the outer surface 1204 of the male projection 1202, so that the female socket 1201c and male projection 1202 operatively align. In the example shown in FIG. 14, the inner surface 1203 and the outer surface 1204 are frustoconical or otherwise tapered. A latch 1205 is coupled to socket 1201c to selectively lock a corresponding male projection 1202 in socket 1201c to retain the car seat 10 in a connected configuration to the frame 600″. For example, as shown in FIGS. 12 and 14, the latch 1205 is pivotally connected to the socket 1201c and is biased with a spring 1206 so that the latch 1205 is biased to move leftward into a closed position that is shown in FIG. 14. The male projection 1202 has an annular flange 1207 at an upper end of the frustoconical surface 1204. The latch 1205 is configured to slide along annular flange 1207. Sockets 1201a, 1201b, 1201d, and 1201e may have the same construction as socket 1201c, but may optionally omit having the latch 1205, as in the embodiment shown in FIG. 12.

During a connection process of the car seat 10 to the frame 600″, a user places the car seat 10 over the frame 600″ with the male projections 1202 extending downwardly facing the sockets 1201 and places the seat 10 on the frame 600″ preferably in the vicinity of the sockets 1201. If the male projections 1202 do not initially align with the sockets 1201, the user can slide the car seat 10 front to back and/or left to right relative to the frame 600 until the projections 1202 align with the female sockets 1201. When the projections 1202 and the female sockets 1201 are aligned, the user can push the seat 10 further downward into the frame to move the latch 1205 to the side of the opening of the socket 1201 and into an open position to clear the annular flange 1207 of the male projection 1202. Once the male projection 1202 is fully seated in the female socket 1201c, the latch 1205 automatically moves to the side over the upper flange 1207 of the male projection 1202, thereby locking the projection 1202 in the socket 1201c. The female socket 1201c can be unlocked from the male projection 1202 by displacing the latch 1205 to clear of the annular flange 1207 of the projection 1202, such as using a handle 1208 (FIG. 12) and pulling the seat 10 upward. Also, optionally, a spring 1209 may be positioned in the bottom of the sockets 1201 to urge the seat 10 away from the frame to facilitate separating the seat 10 from the frame by having the seat automatically lift slightly upwards once the latch 1205 is displaced from the locking position to the open position.

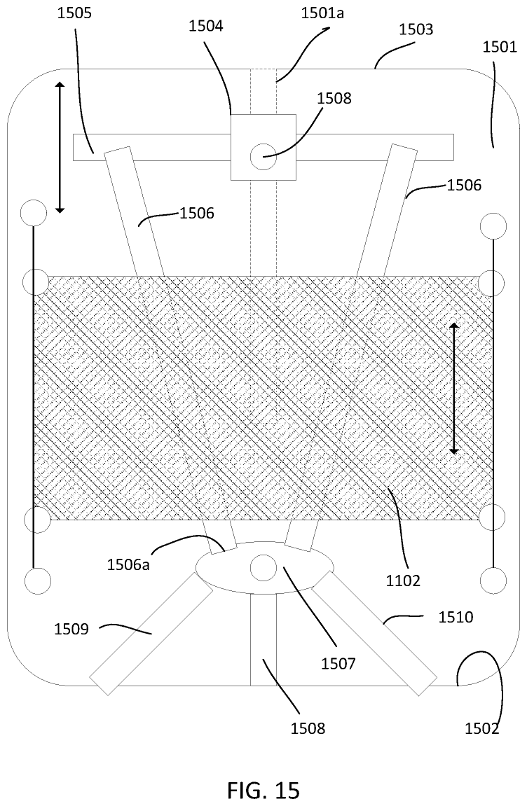

FIG. 15 shows a schematic view of another harness system 1500 for a car seat in accordance with an aspect of the disclosure. FIG. 15 shows a seat back 1501 and seat bottom 1502 of an inner seat 1503, which can be a substitute for inner seat 30 of car seat 10. The seat back 1501 defines a central vertical slot or track 1501a through which is configured to receive a height adjuster 1504, further details of which are described in greater detail below. Also, the inner seat 1503 is shown incorporating the panel 1102, described above, which is configured for vertical height adjustment and can bolster the occupant of the inner seat.

The harness system includes a harness shoulder pad height adjuster 1504 that rides in the vertical slot 1501a. Extending laterally from the adjuster 1504 are shoulder pads 1505 which also extend (forward, out of the page in FIG. 15) a sufficient amount so that the pads 1505 can extend over the shoulders of the occupant of the inner seat 1503. Belts or straps 1506 extend from the shoulder pads 1505 to a crotch buckle connector 1507, such as the crotch buckle used in five-point harnesses known in the art. The belts or straps 1506 have connectors 1506a that connect with the crotch buckle connector 1507. The belts or straps 1506 have adjustable lengths and may include a belt adjuster (not shown), which are known in the art. The crotch buckle connector 1507 is connected to the seat bottom 1502 of the inner seat 1503 with a crotch strap 1508. Thigh straps 1509 and 1510 extend from the seat bottom 1502 to the crotch buckle 1507. The adjuster 1504 is configured to adjust the distance of the shoulder pads 1505 relative to the seat bottom 1502. Specifically, the adjuster 1504 has a release button or actuator 1508 to permit a user to adjust the height of the adjuster 1504. When the actuator 1508 is not depressed, the adjuster 1504 is configured in a locked position and cannot move relative to the seatback 1501. Depressing the button 1508 unlocks the height adjuster 1504 to permit it to be adjusted vertically to reposition the shoulder pads 1505.

In use, prior to seating a child in the inner seat 1503, the panel 1102 is drawn away or removed as described above with respect to FIG. 11 and the straps 1506 are disconnected from the crotch buckle connector 1507. The straps 1506 may be raised over the top of the seat back 1501 or to the side to make room for seating the child in the seat 1503. If the child is being seated in the seat 1503 for the first time, the height adjuster 1504 may preferably be raised to its upper limit in the slot 1501a to ensure sufficient clearance for placement of the child in the seat 1503. After the child is seated in the inner seat 1503, a user may lower the shoulder pads 1505 using the adjuster 1504 so that the shoulder pads 1505 engage or are slightly above the shoulders of the child. Then, the user may connect the connectors 1506a of the straps 1506 to the crotch buckle connector 1507 and optionally adjust the length of the straps 1506 to remove any excess slack. Finally, a user may cover over the straps 1506 with the panel 1102 and secure it fully to the inner seat 1503 as described above with respect to FIG. 11. The foregoing steps can be reversed to remove the occupant from the inner seat 1503.

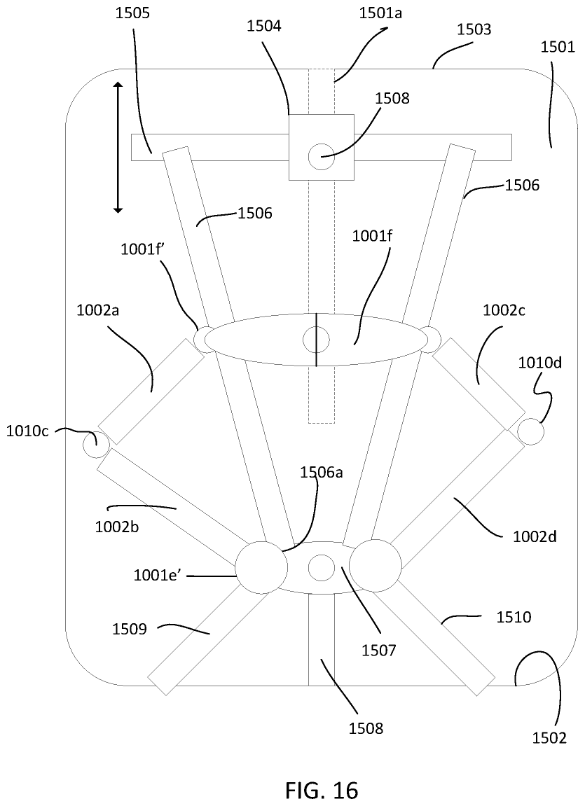

FIG. 16 shows an alternative to the harness system shown in FIG. 15 where the panel 1102 is replaced with the above-described side bolster straps 1002a-1002d of harness system 1000 in FIG. 10 and the associated connections 1010c, 1010d, 1001e′, and 1001f. The incorporation of the side bolster straps 1002 with the straps 1506 and the height adjuster 1504 and shoulder pads 1505 also employs the use of the chest buckle 1001f. The side bolster straps 1002a-1002d have the same function and operate in the same manner in the arrangement shown in FIG. 16 as they do in the arrangement shown in FIG. 10.

In one embodiment, the crotch buckle connector is operatively linked, such as with a cable running under and behind the seat bottom and seat back, with the adjuster 1504 such that when the user disconnects the connectors 1506a from the crotch buckle connector 1507, the shoulder pads 1505 automatically rise upward a certain amount relative to their original position before unbuckling (e.g., 1 to 3 inches) or to the maximum height permitted by the slot 1501a to provide additional clearance for facilitating removal of the child from the inner seat 1503.

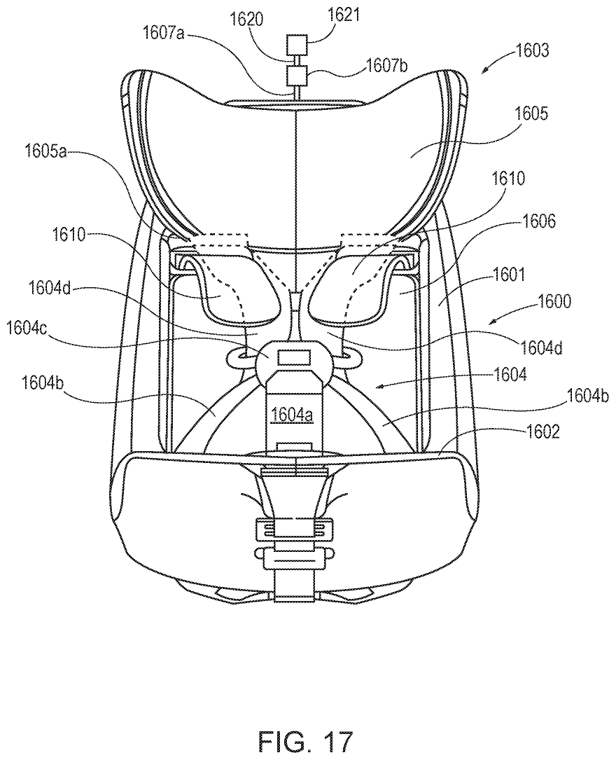

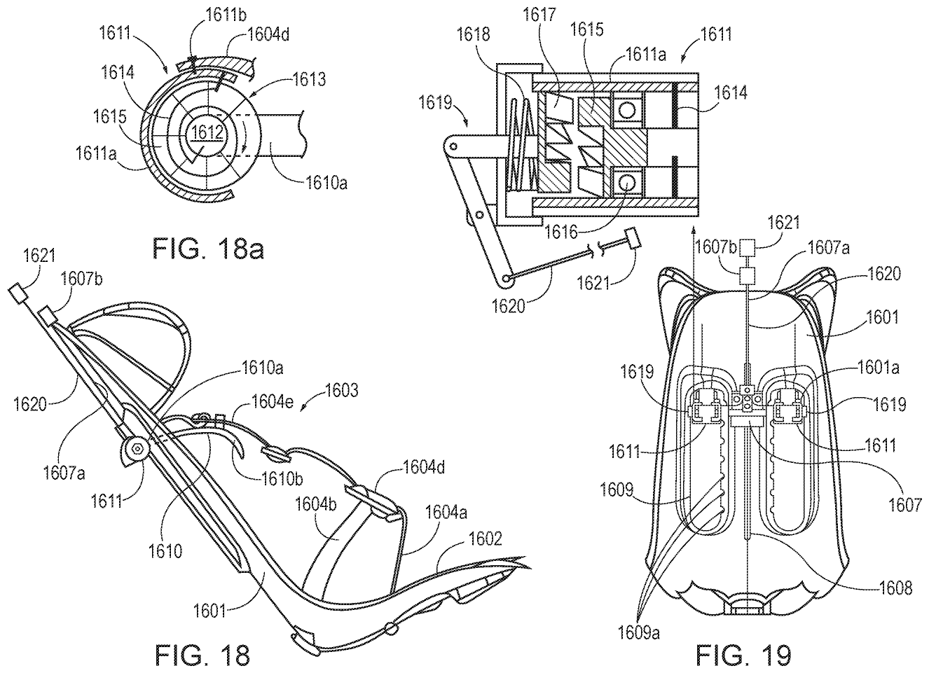

FIGS. 17 to 19a show another embodiment of an inner seat 1603 including a harness system 1600. FIGS. 17 and 18 show a seat back 1601 and seat bottom 1602 of the inner seat 1603, which can be a substitute for inner seat 30 of car seat 10. The harness system 1600 includes a five-point harness 1604 having crotch strap 1604a, a pair of lap belts 1604b, a crotch buckle 1604c, and a pair of shoulder belts 1604d.

Laid over the seatback 1601 is a headrest 1605 and a back pad 1606 continuously connected with the headrest 1605. As will be described hereinbelow, the headrest 1605 and back pad 1606 are configured to slide vertically with respect to the seatback 1601 to permit height adjustment for the headrest and the shoulder straps 1604d. Indented grooves 1605a are defined between the headrest 1605 and the back pad 1606 to provide space for routing the shoulder straps 1604d as well as shoulder pads 1610, further details of which are provided below.

Also shown in FIG. 17, shoulder pads 1610 extend forward through the seat back 1601 and in the indented grooves 1605a. As shown more clearly in FIG. 18, vertical slots 1609 are defined in the seatback 1601 of the seat 1603 and the rear ends 1610a (FIGS. 18a, and 19) of the shoulder pads 1610 extend through the slots 1609. In FIG. 17 the slots 1609 are partly covered (but partly exposed in the area of the indented groove 1605a) by the headrest 1605 and back pad 1606. As shown in FIGS. 17 and 18, the shoulder pads 1610 extend along and under the shoulder straps 1604d. The rear ends 1610a of the shoulder pads 1610 and the rear ends of the shoulder straps 1604d are configured to move vertically in slots 1609 in fixed relation to the headrest 1605 when the headrest 1605 height is adjusted, as described in greater detail below.

As shown in FIGS. 18 and 18a, the rear ends of the shoulder pads 1610 and the shoulder straps 1604d are connected to hollow cylinders 1611 located behind the seat back 1601. In the embodiment shown, a height adjuster 1607, shown in greater detail in FIG. 19, is connected to the cylinders 1611 behind the seatback 1601, and is also connected to the headrest 1605 and back pad 1606 through a central vertical slot 1608 defined in the seatback 1601. The height adjuster 1607 and cylinders 1611 are configured to move together vertically in unison so that selective movement of the height adjuster 1607 up or down in the slot 1608 will cause the vertical position of the headrest 1605, the rear ends of the shoulder straps 1604d, and the rear ends of the shoulder pads 1610 to move simultaneously, e.g., to facilitate adjusting the seat 1603 to accommodate a seat occupant.

Specifically, inner edges (with regard to proximity to slot 1608) of the vertical slots 1609 have notches 1609a, into which the height adjuster can be selectively locked into position with respect to the slot 1608 in the seatback 1601. The height adjuster 1607 is connected to a tether 1607a (FIGS. 17, 18, and 19) and a handle 1607b (FIGS. 17, 18, and 19), which can be pulled by the user to unlock the height adjuster 1607 for vertical adjustment of the headrest 1605, the shoulder straps 1604d, and the shoulder pads 1610. The shoulder straps 1604d, the cylinders 1611, the shoulder pads 1610, the headrest 1605, and the back pad 1606 are coupled together and are configured to move together in a vertical direction relative to the seatback 1601 when the height of the headrest 1605 and shoulder straps 1604d are adjusted using the handle 16070b. Thus, as the occupant grows taller, for example, the heights of the rear end of the shoulder straps 1604d, as well as the rear end 1610a of the shoulder pads 1610, can be raised to accommodate any increase in height of the occupant's shoulders relative to the seat 1602.

The shoulder pads 1610 extend forward of the seat back 1601 and have a curved front, free end 1610b (FIG. 18). In the embodiment shown, the shoulder pads 1610 extend forward with respect to the seatback 1601 a sufficient distance so that the pads 1610 can extend over and in front of the shoulders of the occupant of the inner seat 1603 so that the curved end extends partially down (towards the seat 1602) from the shoulders and may extend partially over the chest of the occupant. The shoulder pads function to limit relative vertical movement of the occupant with respect to the seat 1603, such as might occur in the event of a collision of a vehicle to which the seat 1603 is connected.

As shown in greater detail in FIG. 18a, the cylinder 1611 has an outer wall 1611a that is axially stationary and extends generally horizontally. A rear end of the shoulder straps 1604d are fixed (such as with a fastener 1611b) to the outer wall 1611a. A central axle 1612 extends through each cylinder 1611. The axle 1612 is fixed to the rear end 1610 of a respective shoulder pad 1610. The axle 1612 and the connected rear end 1610a of the shoulder pad 1610 are selectively permitted to rotate about an axis through the length of the axle 1612. The shoulder pad 1610 can rotate through an arc defined by a gap 1613 cut in the cylinder wall 1611a. In one embodiment, the arc may be about 65 degrees. The axle 1612 may be coupled to the outer wall 1611a with a spring 1614 to rotationally bias the axle 1612 so that when the axle 1612 is permitted to freely rotate, the spring 1614 can urge a respective shoulder pad 1610 to rotate upwardly, possibly all the way to the top edge of the gap 1613 cut into the cylinder wall 1611a.

As shown in FIG. 18a, the axle 1612 is rotationally fixed to a stepped gear 1615. The gear 1615 and axle 1612 are rotationally supported by a bearing 1616. Also shown in FIG. 18a is an opposing stationary stepped gear 1617, which is biased by a spring 1618 to engage the axle-mounted stepped gear 1615 in one-way ratcheting engagement. The engagement of the axle-mounted gear 1615 with the stationary stepped gear 1617 permits the shoulder pads 1610 to be pulled downward (i.e., to secure the seat occupant), but prevents the shoulder pads 1610 from being pulled upward (i.e., preventing the seat occupant from unsecuring the shoulder pads 1610). FIG. 19a shows an example of a release mechanism 1619 which is selectively operated by a pull cable 1620 routed along the rear side of the seatback 1601 (as shown in FIGS. 17, 18, and 19) to a handle 1621 (as shown in FIGS. 17, 18, and 19) located above the seatback 1601. When not pulled by a user, spring 1618 urges the gears 1615 and 1617 into meshed engagement, which will only permit the shoulder pad 1610 to be rotated downwardly (if the shoulder pads 1610 are not already in contact with the seat occupant). When the handle 1621 is pulled upwardly, the cable 1620 is pulled upwardly, causing the release mechanism 1619 to disengage the stationary gear 1617 from the axle-mounted gear 1615, which permits the axle and the shoulder pads to freely rotate relative to the cylinder wall 1611a. Once the user pulls up on the handle 1621, the user can rotate the shoulder pads 1610 upward (or downward) or, if the spring 1614 is present, the shoulder pads 1610 will automatically rotate upward.

There have been described and illustrated herein several embodiments of a car seat, car seat system, and harness system. While particular embodiments of the invention have been described, it is not intended that the invention be limited thereto, as it is intended that the invention be as broad in scope as the art will allow and that the specification be read likewise. Thus, while particular shapes of the straps have been disclosed for the suspension system, it will be appreciated that other forms for the straps may be used as well. For example, the straps may have additional or other curvatures to those shown and may have more attachment points per strap. In addition, while particular types of strap and frame materials have been disclosed, it will be understood that other materials can be used. For example, the suspension system may be comprised of straps formed of at least one of metal, composite, and plastic, and which are rigid but deformable at at least a certain force, such as at a force of between 20 g to 100 g (measured as g-forces), for example. Also, each strap of the suspension system may be of the same or different material construction from the others. For example, the material construction of the straps may vary depending on their location in the car seat. Furthermore, while cylindrical members have been shown as forming the frame, it will be understood that other shapes can be similarly used. It will therefore be appreciated by those skilled in the art that yet other modifications could be made to the provided invention without deviating from its spirit and scope as claimed.

1.-26. (canceled)

27. A car seat harness system comprising:
a five point harness configured for coupling to a car seat, said five point harness including two shoulder straps, a chest buckle for connecting the shoulder straps together, two thigh straps, a crotch strap, and a crotch buckle for connecting the shoulder straps, the crotch strap, and the thigh straps together; and
at least one of (i) a bolster panel configured to be coupled to the car seat, and cover over at least the shoulder straps and the chest buckle of the five point harness, and (ii) a first pair of straps configured to extend between the chest buckle and respective connection locations on opposite lateral sides of the five point harness; and
a second pair of straps configured to extend between the crotch buckle and the respective connection locations.

28. The system of claim 27, wherein:
the bolster panel is configured to be vertically adjustable with respect to the shoulder straps.

29. A car seat for an occupant, comprising:
a) an outer protective shell;
b) an inner seat;
c) a suspension system comprised of suspension elements that couple and permit relative movement between said inner seat and said outer protective shell, said suspension system suspending said inner seat substantially within said outer protective shell,
wherein the suspension elements include an outer plastically deformable band surrounding a plastically deformable insert.

30. The car seat according to claim 29, wherein: a first length of each band is connected to an outer surface of said inner seat and a second length of each band is connected to an inner surface of said outer protective shell.

31. The car seat according to claim 29, wherein: said straps are formed of at least one of metals and plastics.

32. The car seat according to claim 29, wherein: the insert includes an outer filler material that surrounds an inner filler material, wherein the inner filler material is more compressible than the outer filler material.

33. The car seat according to claim 32, wherein: the outer filler material has an inner surface configured to limit the amount of deformation of the suspension element.

34. A car seat for an occupant, comprising:
a) an outer protective shell; and
b) an inner seat suspended from said outer protective shell and suspended within said outer protective shell, said inner seat defining at least one vertical slot through a seatback portion of said inner seat;
c) a harness system for securing an occupant to said car seat, the harness system being coupled to said inner seat, and said harness system including:
a shoulder pad height adjuster configured to slide vertically within said at least one vertical slot in said inner seat,
a pair of shoulder pads extending horizontally from said shoulder pad height adjuster,
a pair of shoulder straps connected to respective shoulder pads and extending to a connector,
a crotch strap and crotch buckle coupled to a seat base of said inner seat, said crotch buckle configured to connect to said connectors of said shoulder straps,
wherein said shoulder pad height adjuster is configured to be selectively positioned at a user-selected height to adjust the height of the shoulder pads.

35. The car seat of claim 34, further comprising: a bolster panel configured to be coupled to the car seat across a seatback area of the inner seat and cover over at least the shoulder straps and extend between the shoulder straps.

36. The car seat of claim 34, further comprising: a chest buckle connecting the shoulder straps together at a location vertically spaced above the crotch buckle; a first pair of straps configured to extend between the chest buckle and respective connection locations on opposite lateral sides of the shoulder straps; and a second pair of straps configured to extend between the crotch buckle and the respective connection locations.
